(19) United States
(12) Patent Application Publication
(10) Pub. No.: US 2017/0032368 A1
(43) Pub. Date: Feb. 2, 2017

(54) Systems and Methods for Authenticating Account Users

(71) Applicant: MASTERCARD INTERNATIONAL INCORPORATED, Purchase, NY (US)

(72) Inventors: Michael Clay Atkins, Dublin (IE); Eugene Khvostov, Cliffside Park, NJ (US)

(21) Appl. No.: 14/813,722

(22) Filed: Jul. 30, 2015

(51) Int. Cl. G06Q 20/40; G06Q 20/10; G06Q 30/02

(52) U.S. Cl. CPC G06Q 20/401; G06Q 30/0224; G06Q 20/10

(57) ABSTRACT

Systems and methods are provided for authorizing a user in connection with a request by the user to register an account for one or more services, to thereby confirm that the user is associated with the account. One exemplary method generally includes accessing data stored in a database for an account, in response to a request from a user to register the account for one or more new services; requesting confirmation from the user, at a user device, of at least one detail associated with the accessed data; comparing, at a computing device, location data for the user to base location data identified from the accessed data; and generating, at the computing device, a score for the request based on the comparison, where the score is indicative of whether or not the user, associated with the request, is also associated with the account.

### FIELD

The present disclosure generally relates to authenticating account users. More particularly, the present disclosure relates to systems and methods for use in confirming that new users, when requesting access to payment accounts (e.g., users requesting access to the payment accounts for the first time through one or more applications, users requesting to register the payment accounts for new services, etc.), are actually associated with the payment accounts (e.g., the payment accounts were opened by the users, the payment accounts are in the name of the users, etc.), to thereby help assure that the requested access is appropriate.

### BACKGROUND

This section provides background information related to the present disclosure which is not necessarily prior art.

Consumers use payment devices, and payment accounts associated therewith, in transactions to purchase various products from merchants (e.g., goods and/or services, etc.). The payment devices, and the associated payment accounts, are typically provided to the consumers by issuers. And, the transactions involving the payment devices are typically processed to the payment accounts through payment networks such as, for example, MasterCard®, Visa®, etc. In addition, various services are often available to the consumers for their payment accounts, through various providers, to enhance user experiences with the payment accounts, to improve security of the payment accounts, etc.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in authenticating consumers in connection with requests by the consumers to access payment accounts, to help ensure that the consumers are actually associated with the payment accounts and that the requested access is appropriate;

FIG. 2 is a block diagram of a computing device that may be used in the exemplary system of FIG. 1; and

FIG. 3 is an exemplary method that may be implemented in connection with the system of FIG. 1 for authenticating a consumer in connection with a request, by the consumer, to register a payment account for a new service.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Consumers use payment devices, associated with payment accounts, to purchase products (e.g., goods and/or services, etc.) from merchants. Various services are often provided and/or made available to the consumers for the payment accounts (e.g., transaction notifications, account balance monitoring, etc.), through various providers, to enhance user experiences with the payment accounts, to improve security of the payment accounts, etc. In connection therewith, the consumers often request access to the payment accounts in order to modify existing services for the payment accounts, or register for new services when available through the various providers. Uniquely, the systems and methods described herein operate to authenticate the consumers, in connection with the access requests, to help ensure that the consumers are actually associated with the payment accounts and that the requested access is appropriate.

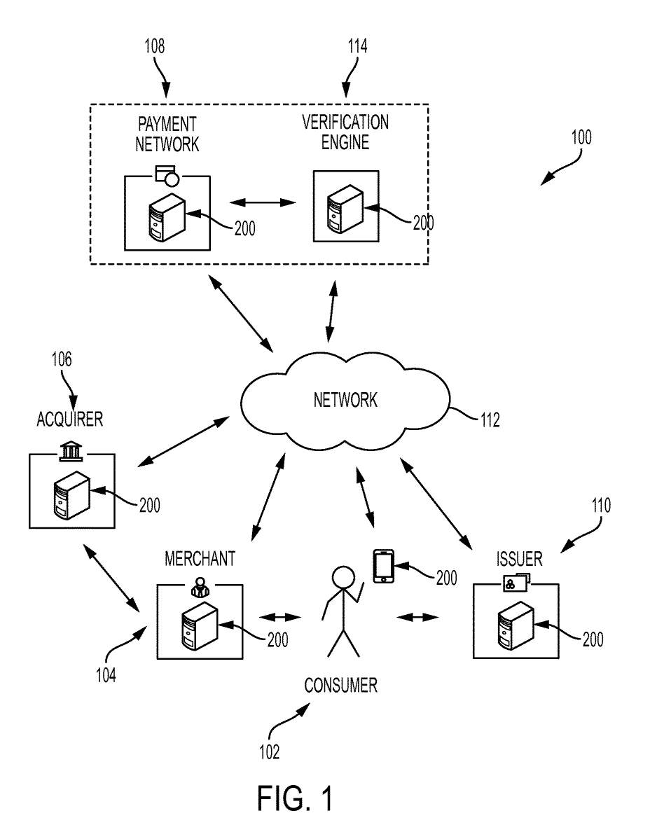

FIG. 1 illustrates an exemplary system 100 in which one or more aspects of the present disclosure may be implemented. Although components of the system 100 are presented in one arrangement, it should be appreciated that other exemplary embodiments may include the same or different components arranged otherwise, for example, depending on interactions and/or relationships between various components when processing purchase transactions, accessing transaction data, accessing location data, authenticating consumers, etc.

The illustrated system 100 generally includes a consumer 102 (broadly, a user), a merchant 104, an acquirer 106, a payment network 108, and an issuer 110, each coupled to network 112. As will be described in more detail hereinafter, the consumer 102 can transact with the merchant 104 for the purchase of products. In order to process the purchase transaction, typically, the merchant 104 enrolls with the payment network 108 (e.g., through the acquirer 106, etc.), which then coordinates approval, clearance, settlement, etc. of the transaction through the system 100. While only one consumer 102, one merchant 104, one acquirer 106, one payment network 108, and one issuer 110 are shown in FIG. 1, it should be appreciated that a different number of one or more of these entities may be included in other embodiments.

The network 112 of the illustrated system 100 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated components of the system 100, or any combination thereof. In one example, the network 112 includes multiple networks, where different ones of the multiple networks are accessible to different ones of the illustrated components in FIG. 1.

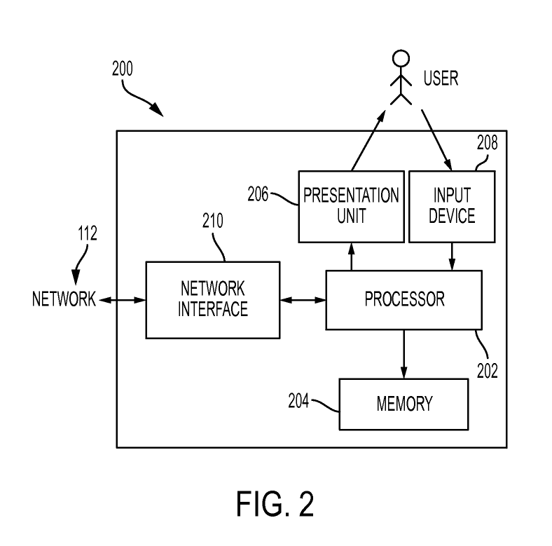

In the system 100, each of the consumer 102, the merchant 104, the acquirer 106, the payment network 108, and the issuer 110 is associated with, or implemented in, a computing device. For illustration, the system 100 is described with reference to exemplary computing device 200, illustrated in FIG. 2. The computing device 200 associated with the consumer may be a portable communication device (or, broadly, a user device) such as a smartphone, etc. And, each of the consumer 102, the merchant 104, the acquirer 106, the payment network 108, and the issuer 110 is associated with such a computing device 200. However, the system 100 and its components should not be considered limited to the computing device 200 of FIG. 2, as different computing devices and/or arrangements of computing devices may be used. In addition, different components and/or arrangements of components may be used in other computing devices. Further, in various exemplary embodiments, the computing device 200 may include multiple computing devices located in close proximity, or distributed over a geographic region (such that each computing device 200 in the system 100 may represent multiple computing devices, etc.). Additionally, each computing device 200 illustrated in the system 100 may be coupled to a network (e.g., the Internet, an intranet, a private or public LAN, WAN, mobile network, telecommunication networks, combinations thereof, or other suitable network, etc.) that is either part of the network 112, or separate therefrom.

By way of example (and without limitation), each computing device 200 included in the system 100 may include one or more servers, workstations, personal computers, laptops, tablets, PDAs, telephones (e.g., cellular phones, smartphones, other phones, etc.), point of sale (POS) terminals, combinations thereof, etc. as appropriate.

As shown in FIG. 2, the exemplary computing device 200 generally includes a processor 202, and a memory 204 coupled to the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The processor 202 may be a single core, a multi-core processor, and/or multiple processors distributed within the computing device 200. The above examples are exemplary only, and are not intended to limit in any way the definition and/or meaning of processor.

The memory 204, as described herein, is one or more devices that enable information, such as executable instructions and/or other data, to be stored and retrieved. The memory 204 may include one or more computer-readable media, such as, without limitation, dynamic random access memory (DRAM), static random access memory (SRAM), read only memory (ROM), erasable programmable read only memory (EPROM), solid state devices, flash drives, CD-ROMs, thumb drives, tapes, flash drives, hard disks, and/or any other type of volatile or nonvolatile physical or tangible computer-readable media. The memory 204 may be configured to store, without limitation, data relating to payment accounts, data for transactions processed to the payment accounts, location data for users, scores or other indicators relating to authentication of account users, and/or any other types of data suitable for use as described herein, etc.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer-readable media. It should be appreciated that the memory 204 may include a variety of different memories, each implemented in one or more of the functions or processes described herein.

The illustrated computing device 200 also includes a presentation unit 206 that is coupled to the processor 202. The presentation unit 206 outputs, or presents, to a user (e.g., the consumer 102; individuals associated with one or more of the merchant 104, the acquirer 106, the payment network 108, and the issuer 110 in the system 100; etc.) by, for example, displaying, audibilizing, and/or otherwise outputting data such as, but not limited to, data relating to payment accounts, data for transactions processed to the payment accounts, location data for users, data relating to authentication of account users, and/or any other type of data. It should be further appreciated that, in some embodiments, the presentation unit 206 comprises a display device such that various interfaces (e.g., applications, webpages, etc.) may be displayed at computing device 200, and in particular at the display device, to display such information and data, etc. And in some examples, the computing device 200 may cause the interfaces to be displayed at a display device of another computing device, including, for example, a server hosting a website having multiple webpages, etc. With that said, presentation unit 206 may include, without limitation, a liquid crystal display (LCD), a light-emitting diode (LED) display, an organic LED (OLED) display, an “electronic ink” display, speakers, combinations thereof, etc. In some embodiments, presentation unit 206 includes multiple units.

The computing device 200 further includes an input device 208 that receives input from the user. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. Further, in some exemplary embodiments, a touch screen, such as that included in a tablet, a smartphone, or similar device, behaves as both a presentation unit and an input device. In at least one exemplary embodiment, a presentation unit and/or an input device are omitted from a computing device.

In addition, the illustrated computing device 200 includes a network interface 210 coupled to the processor 202 (and, in some embodiments, to the memory 204 as well). The network interface 210 may include, without limitation, a wired network adapter, a wireless network adapter, a mobile telecommunications adapter, or other device capable of communicating to one or more different networks, including the network 112. In some exemplary embodiments, the computing device 200 includes the processor 202 and one or more network interfaces incorporated into or with the processor 202.

Referring again to FIG. 1, generally in the system 100, the consumer 102 initiates a transaction at the merchant 104 for a desired product by presenting payment account information to the merchant 104 in connection with the transaction. In response, the merchant 104, the acquirer 106, the payment network 108, and the issuer 110 cooperate to authorize and clear the transaction. In particular, the merchant 104 reads the payment account information from the consumer 102 and (via the acquirer 106) communicates with the issuer 110, through the payment network 108 (e.g., using the MasterCard® interchange, etc.), for authorization for the transaction. If the issuer 110 accepts the transaction, an authorization response is provided back through the payment network 108 (and the acquirer 106) to the merchant 104. Upon authorization, the transaction generally is completed. The credit of the payment account used by the consumer 102 in the transaction is altered by the amount of the transaction, and the transaction is posted to the consumer's payment account. The transaction is later settled and cleared by and between the acquirer 106 and the issuer 110, directly or via the payment network 108. Other transactions in the system 100 are processed in a similar manner.

In the above transaction, the consumer's payment account can be associated with any suitable payment device issued to the consumer 102 such as, for example, a payment card (e.g., a credit card, a debit card, a pre-paid card, etc.), another payment device (e.g., a fob, etc.), a payment-enabled device (e.g., a smartphone, tablet, a laptop, etc.), such as the consumer's computing device 200, through which login credentials for a previously established purchase account can be entered (e.g., to enable use of an electronic wallet such as MasterPass™, Google Wallet, PayPass™, Softcard®, etc.), etc. In addition, while the above transaction is described with reference to a particular routing of data through the system 100, it should be appreciated that the merchant 104, the acquirer 106, the payment network 108 and the issuer 110 may perform one or more functions differently, and may communicate directly or indirectly with each other or with other entities, in order to authorize and/or clear the transaction (or one or more other transactions).

Transaction data is generated as part of the authorization, clearing and settlement interactions among the consumer 102, the merchant 104, the acquirer 106, the payment network 108, and the issuer 110 in the above transaction (and in other transactions in the system 100). Depending on the transaction, the transaction data is transmitted from the merchant 104 to the issuer 110 through the payment network 108 or otherwise (e.g., as part of authorizing, clearing, and/or settling the transaction, etc.). The transaction data includes various details of the transaction such as, and without limitation, the payment account number (PAN) for the consumer's payment account involved in the transaction, a payment amount for the product(s) involved in the transaction, identifier(s) for the product(s) involved in the transaction, description(s) of the product(s) involved in the transaction, a merchant name for the merchant 104 involved in the transaction, a merchant identification number (MID) for the merchant 104 involved in the transaction, a merchant category code (MCC) assigned to the merchant 104 involved in the transaction (e.g., by the payment network 108 or by another, based on a type of product(s) provided by the merchant 104, etc.), a date and/or time of the transaction, a location of the transaction, etc.

Once generated, the transaction data is stored in one or more different components of the system 100. In the illustrated embodiment, for example, the payment network 108 collects the transaction data and stores it in memory 204 of associated computing device 200 (e.g., in a data structure associated with the memory 204, etc.). As such, the payment network 108 includes, in memory 204, a compilation of consumers and merchants involved in the various transactions processed by the payment network 108 (through the system 100, etc.), and the corresponding transaction data for the transactions. Further, the transaction data can be stored by the payment network 108, in memory 204, in various different manners, for example, according to the payment accounts used by consumers in the system 100, merchants involved in the transactions (e.g., the MID for each of the merchants involved, the MCC for each of the merchants involved, etc.), or any other criteria, such that the transaction data is readily usable as described herein. It should be appreciated that the same or different transaction data may be collected and stored within other components of the system 100. In addition, while the transaction data is described as stored in the memory 204 of the computing device 200 associated with the payment network 108, it should be appreciated that the transaction data could be stored apart from the memory 204 (e.g., in a data structure apart from the computing device 200, etc.) in various implementations.

In some implementations of the system 100, other transaction data may also be generated and stored in the system 100 in connection with various transactions including, for example, data captured by the merchant 104 (e.g., product descriptions such as a product name, a flight number for flight-related purchases, etc.), data captured by the issuer 110, data captured by the system 100 for particular payment devices used by consumers (e.g., data captured for transactions involving commercial payment cards, etc.), etc.

In addition, in some implementations, social data (broadly, still transaction data) may further be generated and stored in the system 100 (e.g., directly via applications supported by entities of the system 100, or as received from third-party providers, etc.). Such social data may include, for example, social network data generated in response to interactions by consumers with different social network applications (e.g., and relating to particular products, merchants, etc.), etc. Further, data from third-party providers, or vendors, may be collected by the system 100, and stored therein, including, for example, enhanced transaction information, etc.

In various exemplary embodiments, consumers (e.g., consumer 102, etc.) involved in the different transactions herein agree to legal terms associated with their payment accounts, for example, during enrollment in their accounts, etc. In so doing, the consumers may agree, for example, to allow merchants (e.g., merchant 104, etc.), issuers of the payment accounts, payment networks, etc. to use data collected during enrollment and/or collected in connection with processing the transactions, subsequently for one or more of the different purposes described herein (e.g., for verifying payment accounts, etc.).

With continued reference to FIG. 1, the system 100 also includes engine 114 configured to authenticate the consumer 102 in connection with a request by the consumer 102 to access his/her payment account, for example, to register the payment account for a new service, etc. As previously described, various services are often provided and/or made available to the consumer 102 for his/her payment account (e.g., transaction notifications, account balance monitoring, etc.), through various service providers (e.g., the payment network 108, issuer 110, other entity, etc.), to enhance the consumer's experience with the payment account, to improve security of the payment account, etc. In connection therewith, the consumer 102 may request access to his/her payment account in order to modify existing services, or register the payment account for new services when available through the various service providers. With that in mind, following the access request by the consumer 102, the engine 114 operates to determine if the consumer 102 is associated with the payment account and, thus, if the requested access is appropriate. When the engine 114 determines that the consumer 102 is in fact associated with the payment account, the engine 114 authenticates the consumer 102 and the corresponding request. Otherwise, the engine 114 denies the request, or simply does not authenticate it.

As used herein, a request to access a payment account may include any various request relating to the payment account such as, for example, a request to gain access to the payment account, a request to provide access to the payment account (e.g., to a service provider in connection with registering the payment account for a service available for the payment account through the service provider, etc.) a request (e.g., a new request, etc.) to register the payment account for such a service (e.g., a transaction monitoring service, etc.) provided by the payment network 108, the issuer 110, another service provider, etc.

While the description herein is generally related to transaction data, it should be appreciated that other data may be incorporated, and/or may provide a basis for authenticating a user as described herein. One such example may include transaction data for a loyalty program associated with transactions to a merchant. Another example may include data gained based on access records for a user to a location, for example, to a building, or another facility, where the user is present at the location in which access was gained (along with his/her communication device).

As will be described in more detail with reference to method 300, upon receiving the request from the consumer 102 to access his/her payment account, the engine 114 accesses transaction data for the payment account, from the payment network 108 (via network 112), or from the issuer 110, etc. where transaction data may also be stored (e.g., in a database, etc.). The engine 114 then compares location data for the consumer 102, at a time of the access request, to location data for merchants included in the accessed transaction data. Then, based on the comparison, the engine 114 generates a score (e.g., a color-based score, a numerical-based score, a word/phrase-based score, etc.) indicating a general likelihood of whether or not the consumer 102 is associated with the payment account.

In the illustrated system 100, the engine 114 is associated with, or implemented in, one or more computing devices that facilitate operation of the engine 114 as described herein. For illustration, the engine 114 is described with reference to exemplary computing device 200, illustrated in FIG. 2. However, as previously described, the engine 114 should not be considered limited to the computing device 200, as different computing devices and/or arrangements of computing devices may be used. In addition in the illustrated system 100, the engine 114 is illustrated as a stand-alone entity. However, it is contemplated that the engine 114 could be associated with (or incorporated into) the payment network 108, in some embodiments (as indicated by the broken lines in FIG. 1). Alternatively, in other embodiments, the engine 114 may be incorporated into other entities shown in the system 100 (e.g., the issuer 110, etc.), or not shown.

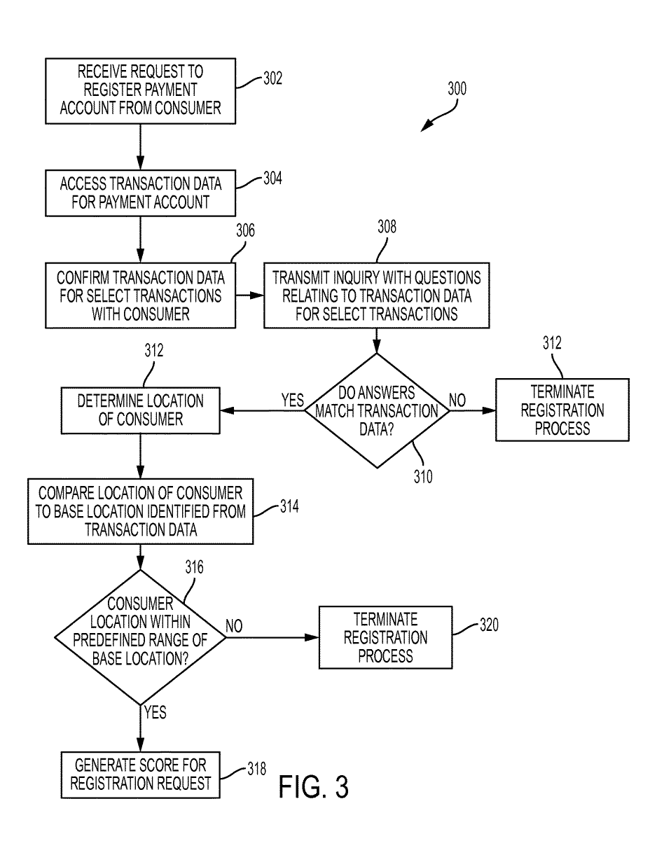

FIG. 3 illustrates exemplary method 300, for use in authenticating the consumer 102 (again, broadly a user) in connection with a request by the consumer 102 to register (broadly, access) his/her payment account for a new service (e.g., from the payment network 108, etc.). In so doing, the method 300 operates to confirm that the consumer 102 is actually associated with the payment account, and that the request from the consumer 102 is proper, prior to completing (or proceeding with) the requested registration. The exemplary method 300 is described herein as implemented in the engine 114 of the system 100, with it understood that the engine 114 is capable of performing one or more of the various operations of the method 300. Further reference is also made to the consumer 102 (and the consumer's payment account and portable communication device), the merchant 104, the acquirer 106, the payment network 108, and the issuer 110. However, it should be appreciated that the method 300 could be implemented in (or in connection with) one or more other entities, in other embodiments.

For purposes of illustration, the exemplary method 300 is also described herein with reference to the computing device 200. And, just as the method 300, and other methods herein, should not be understood to be limited to the exemplary system 100, or the exemplary computing device 200, the systems and the computing devices herein should not be understood to be limited to the exemplary method 300.

In the method 300, when the consumer 102 desires to register his/her payment account, for example, for a new service, the consumer 102 submits a registration request (broadly, an access request), via the consumer's portable communication device (e.g., using an application associated with the payment network 108 or other entity providing the new service, etc.). The registration request includes various data relating to the payment account, including the PAN, so that the payment account can be identified upon receipt of the request. In addition, the registration request may include additional data such as the name of the consumer authorized to access the payment account, etc.

Then in the method 300, the engine 114 then receives the registration request at 302. The registration request may be directly received by the engine 114, from the consumer 102. Or, the registration request may be transmitted to the engine 114, via the network 112, from the payment network 108 or other entity associated with the registration, and the new service, depending, for example, on the registration process for the new service, the particular service involved, etc.

Next, upon receiving the registration request, the engine 114 accesses transaction data for the payment account (e.g., clearing data, etc.), at 304. This includes accessing (and, in some implementations, retrieving) the transaction data, for the payment account, from the memory 204 of the computing device 200 of the payment network 108 (e.g., directly, or via network 112, etc.) (e.g., from a database associated with the memory 204, etc.), for example, for transactions made to the payment account and processed through the payment network 108. The accessed transaction data may then be stored, by the engine 114, in a data structure associated with the engine 114, or otherwise, for subsequent use. In addition, in some embodiments, the accessed transaction data, and, for example, transactions included therein, may also be categorized, previously, or by the engine 114. This may include, for example, assigning a category to the transaction data based on one or more of industries relating to the transactions, consumer identities, merchants involved in the transactions (e.g., merchant names, merchant addresses, MCCs, MIDs, transaction amounts, etc.), etc.

At 306, the engine 114 then confirms with the consumer 102 particular details of the accessed transaction data, for select transactions (e.g., for three randomly selected transactions, etc.). This provides an initial assurance, to the engine 114, that the consumer 102 is associated with the payment account, and did not simply find a receipt for a transaction to the payment account or otherwise obtain the PAN for the payment account improperly or inadvertently. In connection with this initial confirmation, the engine 114 transmits an inquiry to the consumer 102 at 308, through the user's portable communication device, requesting confirmation of the particular details for the select transactions. In the illustrated embodiment, the inquiry includes multiple questions relating to amounts, dates, locations, etc. of the select transactions, theoretically only known to the consumer 102 if associated with the payment account. The engine 114 then compares responses to the questions, from the consumer 102, to the transaction data, at 310. And, when the user's responses match at 310, the engine 114 proceeds in the method 300 with the authorization. Otherwise, the engine 114 declines the registration request, and terminates the registration process, at 312. Other operations may be used, at 306, to confirm particular details of the accessed transaction data in other embodiments.

With that said, it should be appreciated that the accessed transaction data may include all available transaction data, from the payment network 108, for the payment account. Or, the transaction data may be limited, by the engine 114, to transaction data associated with transactions made during a predefined interval (e.g., the last 30 days, the last month, the last three months, the last six months, the last year, the last two years, transaction data since a last access, etc.), etc. In addition, in some embodiments, the engine 114 may also access transaction data from other payment networks and/or from issuers (e.g., the issuer 110, other issuers, etc.), merchants (e.g., the merchant 104, other merchants, etc.) other entities, etc., in addition to the payment network 108, such that multiple sources of transaction data may be accessed. For example, the engine 114 may access data captured by the merchant 104 relating to specific features of products involved in the transactions (e.g., flight numbers for airline tickets, etc.), data captured by the issuer 110, data captured by the system 100 for particular payment devices used by consumers, social data from social media providers, etc.

With continued reference to FIG. 3, when the transaction data is confirmed at 306 (and at 308 and 310), the engine 114 next determines a location of the consumer 102 at 312, at a time of the registration request (e.g., at a time the registration request is submitted, at a time the registration request is received, at a time the registration request is processed, etc.). In particular, and to the extent permitted by local privacy laws and regulations, the engine 114 utilizes cellular data for the consumer 102, associated with the consumer's portable communication device used to submit the registration request, to determine coordinates (e.g., latitude and longitude coordinates, etc.) of the portable communication device and, thus, a location for the consumer 102. Other applications may also, or alternatively, be used by the engine 114 to determine a location of the user including, for example, an IP address associated with the consumer's portable communication device, GPS data associated with the consumer's portable communication device a device ID associated with the consumer's portable communication device, an application associated with the consumer's portable computing device, etc. Or, the location data can be collected by the engine 114 from a third-party aggregator service.

Then, at 314, the engine 114 compares the consumer's determined location to locations (e.g., addresses, zip codes, etc.) of merchants included in the accessed transaction data (broadly, a base location, or base location data, for the merchants as identified from the accessed transaction data). In some implementations, this may include comparing the consumer's location to a base location (e.g., a common zip code, a common city, a common county, etc.) of merchants involved in the most frequent transactions (e.g., based on merchant name, based on MID, based on MCC, etc.) present in the accessed transaction data. In these implementations, the base location is generally assumed to correspond to a residential location of the owner of the payment account. In other implementations, this may include comparing the consumer's location to a base location of merchants involved in the most recent transactions present in the accessed transaction data. Here, the base location is generally assumed to correspond to the most recent, most immediate location of the owner of the payment account. In still other implementations, this may include comparing a time and location of the consumer to a base time and/or location.

When the consumer's determined location is within a predefined range, or radius, (e.g., 1 mile, Smiles, 10 miles, 100 miles, etc.) of the identified base location, at 316, the engine 114 generates a score for the registration request at 318 indicating a general likelihood of whether or not the consumer 102 is associated with the payment account. In the illustrated embodiment, the score includes either a pass score, indicating that the consumer 102 is likely associated with the payment account, or a fail score, indicating that the consumer 102 is not likely associated with the payment account. As such, when the engine 114 generates a pass score for the registration request, the engine 114 (via the score) also authenticates the consumer 102 at 318 and allows the registration process to proceed. Otherwise, the engine 114 terminates the registration process at 320. In some embodiments, when the consumer 102 is authenticated by the engine 114, the engine 114 also transmits an indicator to the consumer 102 to confirm that the consumer 102 has been authenticated. The indicator may include any suitable indicator such as, for example, a symbol, etc.

In some embodiments, in connection with comparing the consumer's determined location to a merchant base location (e.g., at 314), the engine 114 may initially determine if the consumer's location is within a first predefined range of the base location. When the consumer's determined location is within the first predefined range of the base location, the engine 114 generates a first score for the registration request (e.g., a “reasonably certain” pass score, etc.). However, in these embodiments, when the consumer's determined location is not within the first predefined range of the merchant location, the engine 114 proceeds to determine if the consumer's location is within a second, larger predefined range of the base location (e.g., the first predefined range plus 100 miles, etc.). Then, when the consumer's determined location is within the second predefined range of the base location, the engine 114 generates a second score for the registration request (e.g., a “fairly certain” pass score, etc.). Otherwise, when the consumer's determined location is not within the second predefined range of the base location, the engine 114 terminates the registration process. In so doing, the engine 114 generates a score that generally ranks risks of whether or not the registration request if actually from the consumer. In some implementations, the scores may further be transmitted to the payment network 108 or other entity associated with the registration, via the network 112, for use in determining whether or not to proceed with the registration. And, when the scores include a ranking or risks, the payment network 108 or other entity associated with the registration can then make a decision based on an acceptable degree of risk.

In some embodiments, other factors such as a length of time an application has been installed on the consumer's portable communication device, prior registration attempts by the consumer 102 for the new service (or for other services), etc. may be used by the engine 114, or by the payment network 108 or other entity associated with the registration, in connection with deciding whether or not to proceed with the registration. Such data may be available through the engine 114, or from third-party providers.

An example implementation of the method 300 will be described next. The engine 114 receives a request, through the payment network 108, for a new user, Jane, to register her payment account for a new service. The registration is received through an application provided by the payment network 108. The application is available to Jane either through her mobile device 200, or online through her computing device 200. When Jane accesses the application from her mobile device 200, the engine 114 is able to capture location data for Jane's device 200. Similarly, when Jane accesses the application from her computing device 200, the engine 114 captures location data for Jane's device 200 by using its IP address. In either case, Jane provides requested information for the registration, including her payment account number, and submits it to the engine 114.

In this example, in connection with Jane's registration, the engine 114 operates to authenticate Jane (and her payment account) prior to making the new service available to Jane. In so doing, the engine 114 uses the payment account number provided by Jane to scan Jane's spend history and, in this example, specifically a location of a majority of her spend, and compares it to the location data captured from her device 200 (either her mobile device 200 or her computing device 200, depending on which was used to request the registration). If the location identified from Jane's spend history generally matches the location data captured from Jane's device 200, and the engine 114 finds that Jane's device 200 is in the approximate location of her most common spending trends, the engine 114 can be reasonably sure the payment account identified at registration really belongs to Jane and can move her through authentication and registration. However, if the location identified from Jane's spend history does not match the location data captured from Jane's device 200 and/or and the engine 114 finds that Jane's device 200 is not in the approximate location of her most common spending trends, the engine 114 may choose to not register Jane and the payment account she provided during registration. Or, the engine 114 may request additional information from Jane to verify her identity and to confirm that the payment account she provided during registration actually belongs to her.

As an extension of this example, the registration operations facilitated by the engine 114 may be provided as a service to other applications, i.e., applications other than those provided by the payment network 106. In particular, any application that requires registration and that can provide, for example, a payment account number being used in the registration by a user and a location of the user registering at the application, to the engine 114 can enjoy the enhanced authentication capabilities and location mapping services available herein. In a similar manner to the prior example, the engine 114 would compare the user's current location with the location(s) linked to various spend trends for the provided payment account, and return a score based on a confidence with which that user's current location is within the area of the payment account spend trends. The application owner/provider/administrator can then make a more educated and secure authentication/verification decision.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein (e.g., in the claims, etc.).

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one or more of: (a) accessing data stored in a database for an account, in response to a request from a user to register the account for one or more new services; (b) requesting confirmation from the user, at a user device, of at least one detail associated with the accessed data; (c) comparing location data for the user to base location data identified from the accessed data; and (d) generating a score for the request based on the comparison, where the score is indicative of whether or not the user, associated with the request, is also associated with the account.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” or “included with” another element or layer, it may be directly on, engaged, connected or coupled to, or associated with the other element or layer, or intervening elements or layers may be present. As used herein, the term “and/or” includes any and all combinations of one or more of the associated listed items.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for authorizing a user in connection with a request by the user to register an account for one or more services, to thereby confirm that the user is associated with the account, the method comprising:
accessing data, stored in a database, for an account, in response to a request from a user to register the account for one or more new services;
requesting confirmation from the user, at a user device, of at least one detail associated with the accessed data;
comparing, at a computing device, location data for the user to base location data identified from the accessed data; and
generating, at the computing device, a score for the request based on the comparison, the score being indicative of whether or not the user, associated with the request, is also associated with the account.

2. The computer-implemented method of claim 1, wherein the account includes a payment account; and
wherein accessing data stored in the database includes accessing transaction data for the payment account for transactions processed to the payment account within a time interval.

3. The computer-implemented method of claim 2, wherein requesting confirmation includes requesting confirmation from the user, at the user device, of transaction data for at least one transaction associated with the payment account and processed to the payment account within the time interval.

4. The computer-implemented method of claim 2, wherein the base location data comprises a generally common location of merchants involved in the most frequent transactions present in the accessed transaction data.

5. The computer-implemented method of claim 2, wherein the base location data comprises a generally common location of merchants involved in the most recent transactions present in the accessed transaction data.

6. The computer-implemented method of claim 2, wherein generating a score includes:
generating a first score, when the location data for the user is within a first predefined range of the base location data; and
generating a second score, when the location data for the user is outside the first predefined range of the base location data but within a second, larger predefined range of the base location data.

7. The computer-implemented method of claim 1, further comprising receiving the request from the user device; and
wherein the computing device includes multiple distributed computing devices, whereby comparing the location data is at one of the multiple computing device and generating the score for the request is at a different one of the multiple computing device.

8. The computer-implemented method of claim 7, wherein comparing location data includes comparing location data for the user, as identified for the user when the request is received.

9. The computer-implemented method of claim 1, wherein the location data for the user is based on location data associated with the user device associated with the user.

10. A system for use in confirming that a user is associated with an account, in connection with a request by the user to register the account for one or more new services, the system comprising:
a memory comprising data associated with various user accounts; and
at least one processor coupled to the memory and, in response to a request from a user to register an account identified in the request for one or more new services, configured to:
access data for the account from the memory;
transmit an inquiry to a user device associated with the user to verify at least one detail of the accessed data for the account;
determine a location of the user; and
generate a score for the request based on a comparison of the determined location of the user to a base location identified from the accessed data, the score being indicative of whether or not the user is associated with the account identified in the request.

11. The system of claim 10, wherein the accounts in the memory include payment accounts; and
wherein the accessed data includes transaction data associated with transactions made to the payment account.

12. The system of claim 11, wherein the inquiry includes a request to confirm one or more of an amount, a location, and a merchant name associated with the at least one transaction to the payment account.

13. The system of claim 11, wherein the base location is selected from the group consisting of a generally common location of merchants involved in the most frequent transactions present in the accessed transaction data, and a generally common location of merchants involved in the most recent transactions present in the accessed transaction data.

14. The system of claim 13, wherein, in connection with generating a score, the at least one processor is configured to:
generate a first score, when the location for the user is within a first predefined range of the base location; and
generate a second score, when the location for the user is outside the first predefined range of the base location but within a second, larger predefined range of the base location.

15. The system of claim 10, wherein the at least one processor is further configured to identify a time for the request, the determined location of the user based on a location of the user at about the time identified for the request.

16. The system of claim 10, wherein the request includes a request to register a payment account, and wherein the at least one service includes a service for generating alerts when transactions are processed to the payment account.

17. A non-transitory computer readable storage media comprising executable instructions which, when executed by at least one processor, cause the at least one processor to:
receive a request from a user device to register a payment account for one or more services;
access transaction data, stored in a database, for the payment account, in response to the request, for transactions made to the payment account over a predefined interval;
transmit an inquiry to a user, at the user device, to confirm transaction data for at least one transaction made to the payment account over the predefined interval;
identify a location for the user, corresponding to a time of the request; and
generate a score for the request based on a comparison of the determined location of the user to locations of merchants included in the accessed transaction data for the payment account, the score being indicative of whether or not the user is associated with the payment account identified in the request.

18. The non-transitory computer readable storage media of claim 17, wherein the inquiry includes a request to confirm one or more of an amount, a location, and a merchant name associated with the at least one transaction to the payment account.

19. The non-transitory computer readable storage media of claim 17, wherein, in connection with generating the score, the executable instructions, when executed by the at least one processor, further cause the at least one processor to:
generate a first score, when the location for the user is within a first predefined range of the base location; and
generate a second score, when the location for the user is outside the first predefined range of the base location but within a second, larger predefined range of the base location.

20. The non-transitory computer readable storage media of claim 17, wherein the location of the user is based on location data associated with the user device associated with the user.
